(19) United States
(12) Patent Application Publication
(10) Pub. No.: US 2021/0146599 A1
(43) Pub. Date: May 20, 2021

(54) BIAXIALLY ORIENTED TUBULAR BLOWN FILM STRETCHING MACHINE BY ISOSTATIC PRESSURIZED WATER

(71) Applicant: ENZPIRE INDUSTRY COMPANY LIMITED, Bangkok (TH)

(72) Inventor: Arthorn WICHITAMORNLOET, Bangkok (TH)

(21) Appl. No.: 17/046,828

(22) PCT Filed: Apr. 10, 2018
(86) PCT No.: PCT/TH2018/000018

§ 371 Date: Oct. 12, 2020

(51) Int. Cl. B29C 55/28; B29C 55/26

(52) U.S. Cl. CPC B29C 55/28; B29C 55/26

(57) ABSTRACT

Biaxially oriented tubular blown film stretching machine by isostatic pressurized water is a simultaneous biaxial stretching process, invented to stretch a high crystalline tubular blown film substrate with heterophasic structure to form a microporous film substrate, especially for microporous polypropylene film. The system comprises sequential sets of variable speed nip rolls, a temperature control water tank, and a water pump unit. The sequential sets of variable speed nip rolls used to stretch the tubular blown film substrate in machine direction, while hot water is pumped and confined inside the tubular blown film substrate creating an isostatic pressure in bubble, lead to an orientation stretching in transverse direction.

### FIELD OF THE INVENTION

The invention relates to biaxially oriented tubular blown film stretching machine by isostatic pressurized water.

### BACKGROUND OF THE INVENTION

Generally, a plastic production with tubular blown film extrusion, is the production for making a commodity plastic packaging, wherein the circle die of extruder is used to form the thick wall of polymer tube. In this process the chilled air is fed and trapped inside the polymer tube to form the blown film bubble. The inflation air is used to stretch the plastic bubble for providing the orientation of film. After the film bubble cooldown, the bubble is enclosed by a collapsing frame and nip rolls to form the thin film.

While, oil-absorbent film and food-preserved film are made from biaxially oriented polypropylene (BOPP) by cast film extrusion and biaxial stretching process which is performed the orientation into two directions, machine direction (MD) and transverse direction (TD), wherein plastic resin is extruded from a flat die by extruder onto a chilled roll to quench the melted plastic. The quenched film is then passed through a series of roller which used to decrease the film thickness and produce thin film.

Biaxial stretching process is a process for drawing thermoplastic film substrates, either made from amorphous polymers or semi-crystalline polymers improving film properties such as increasing in mechanical strength especially in tensile strength, improving optical properties, barrier properties or permeability.

Currently, the biaxial stretching films like Biaxially Oriented Polypropylene(BOPP), Biaxially-oriented polyethylene terephthalate (BOPET), and Biaxially Oriented Polyamide (BOPA) are widely used in flexible packaging, which almost are produced via stretching a casted film by a tentering process. The tentering process line where the film undergoes biaxial stretching can be classified into 2 categories:

a.) Sequential biaxial orientation stretching

b.) Simultaneous biaxial orientation stretching

Though, there is another biaxial orientation stretching, that does not use a tenter as a drawing machine, a double bubble tubular blown film stretching. This process is very obsolete, now existing only in a shrink film or label which made from PVC polymer. Unlike the tentering process, the substrate that undergoes the double bubble process must form in a tubular blown film, and the types of polymer used rather limit to an amorphous polymer likes PVC as mentioned above, one atmospheric pressure of air is enough to stretch the preheated tubular blown film enlarging to be a bubble, which retain confining the pressurized air inside bubble tightly leading to drawing in transverse direction.

However, in a specific case of a biaxial stretching of a tubular blown film substrate with highly crystallinity and their heterophasic structure will be stretched to form a microporous film, which the pressurized air confined inside will leak out from the bubble.

From global patent searching, there is a lot of single process for producing plastic film such as the Biaxially oriented process, the Tubular blown film extrusion which are typical processes used in plastic industry as the following;

the US patent US09/220,983 explaining polyethylene film production with two-directions of stretching in multi-layer base sheet by stretching one layer to one direction and coating one surface with a resin, stretching the base sheet in transverse direction to the machine direction,

the US patent application US20170001401 A1 describing a process for producing plastic bag with tubular blown film molding,

the US patent application U.S. Pat. No. 3,976,732A disclosing a process and device for producing a hot blown wind, where raw materials are produced semi fluid foam in a tube, and then bring the said foam through a cooling and extruding systems,

the UK patent application with publication number GB2024702 explaining a system and method for producing blown film with better properties by adding an automatic temperature control unit installed at a heat release part of a tube and a faucet in which there is abnormal temperature, the said temperature control unit send a signal to a valve and a cooling ring in order to control air flow in the system, and

the US patent application with publication number U.S. Pat. No. 4,447,387 describing a process for producing blown film from a thermoplastic resin furthering cool air induced into the system so as to increase output rate.

As the prior related patents are mentioned above, it is obviously understood that the exist patents are a production of thin film with the separately use of the Biaxially oriented process, or the Tubular blown film extrusion. However, the product from the former process is extendable thin film which is a raw material for only an amorphous polymer such as Poly Vinyl Chloride (PVC), or food preserved film, but there will have food contamination from oil released from the said film.

However, the film production according to this invention is the stretchable thin film production like the Biaxially oriented process, the Tubular blown film extrusion, particularly the process of hot isostatic pressure which is not exist in the film production circle before in forms of adding stable pressure stream in blown film during a plastic beads' meting process.

With the latter, the blown film has more been extended helping the transverse-direction stretching of melted plastic after the process of compression, be more effective, pores of film be more suitable for using in food preserved industry, and protect the oil released from the film to contact with food leading to a clean food industry.

### SUMMARY OF THE INVENTION

Accordingly, the present invention is directed to a biaxially oriented tubular blown film stretching machine by isostatic pressurized water is a simultaneous biaxial stretching process, invented to stretch a high crystalline tubular blown film substrate with heterophasic structure to form a microporous film substrate, especially for microporous polypropylene film.

The said machine as described in this invention comprises sequential sets of variable speed nip rolls, a temperature control water tank, and a water pump unit.

The sequential sets of variable speed nip rolls used to stretch the tubular blown film substrate in machine direction, while hot water is pumped and confined inside the tubular blown film substrate creating an isostatic pressure in bubble, lead to an orientation stretching in transverse direction.

In conclusion, the said machine in accordance with this invention is novel because there are used the combination of the variety of processes and techniques namely the Biaxially oriented, the Tubular blown film extrusion, and the hot isostatic pressure beyond prior arts involving in. Therefore, the biaxially oriented tubular blown film stretching machine by isostatic pressurized water according to this invention becomes the only possible and effective solution to the exist problems.

### BRIEF DESCRIPTION OF THE INVENTION

Embodiments of the invention are illustrated by way of example and not by way of limitation in the figures of the accompanying drawings, which are included to provide a further understanding of the invention together with the description served to elaborate the principle of the invention so that it may be more fully understood. In the drawings:

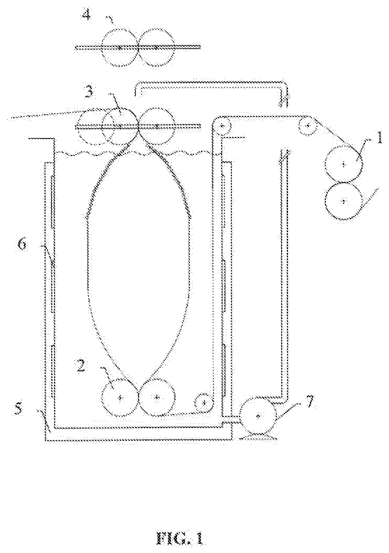

FIG. 1 schematically illustrates an example of the system of biaxially oriented tubular blown film stretching by isostatic pressurized water.

### DETAILED DESCRIPTION OF THE INVENTION

Accordingly, the present invention is directed to a biaxially oriented tubular blown film stretching machine by isostatic pressurized water is a simultaneous biaxial stretching process invented for stretching a continuous tubular blown film substrate made from a highly crystalline polymer with a heterophasic structure that can be stretched to form a microporous film, especially for a microporous film of polypropylene.

The biaxially oriented tubular blown film stretching machine according to invention comprises a plurality of sequential set of variable speed nip rolls (1), (2), (3), (4), a temperature control water tank (5), and a water pump unit (7). The sequential set of nip rolls are used for hauling off and stretching the substrate film or bubble, which a fore nip rolls always moving forward with a higher speed than a rear nip rolls behind leading to rearrangement of the polymer chains called crystallization or orientation, which the proportion of final length per origin length is defined as draw ratio in machine direction, which the ratio depends on the rollers speed of the adjacent pair of nip rolls.

The said machine consists of at least 4 sets of sequential nip rolls. The first set of nip rolls (1) is installed at the outside of the water tank, preferably on the top beside the water tank (5) to feed-in the tubular blown film. The second set of nip rolls (2) is installed in the bottom of the water tank (5), inside the water tank that is used to haul down the tubular blown film substrate and submerged into the water. The third set of nip rolls (3) is installed on the top of the water tank (5) in the same center alignment with the second set of nip rolls (2). The said third set (3) is used to haul up the film or bubble upward. The fourth set of nip rolls (4) is installed above the third set of nip rolls (3), preferably in the same center alignment with the second set of nip rolls (2) and the third set of nip rolls (3) that is used to haul up the stretched tubular blown film during a step of pumping the hot water into the bubble.

Between each pair of nip rolls, the first one (1) to the second one (2) and the second one (2) to the third one (3), the tubular blown film substrate or bubble is drawn in machine direction. While, the transverse direction drawing occurred only in the interval of the second set of nip rolls (2) and the third set of nip rolls (3). The hot water is heated by at least one set of heater bands (6) that coupled to the outside of water tank (5), is pumped and confined inside the tubular blown film substrate to create an isostatic pressure bubble leading to a simultaneous biaxial orientation stretching in both direction, machine direction and transverse direction. The temperature control water tank (5) is contained heated water with temperature in the range of 50 to 100 degree Celsius, wherein the hot water temperature at the uppermost level in the temperature control water tank is higher than the water temperature at the lowermost level in the said tank (5) at least 5 degrees Celsius. The proportion of final diameter of inflated bubble per origin diameter of tubular blown film is defined as draw ratio in transverse direction. The drawing conditions like draw speed, draw temperature, and draw ratio both in machine direction and transverse direction, are relied on the polymer substrate structure and the final film applications.

1. A biaxially oriented tubular blown film stretching machine by isostatic pressurized water is a simultaneous biaxial stretching process, wherein the substrate to be stretched is a continuous tubular blown film substrate, the system comprising:
a plurality of sequential set of variable speed nip rolls;
a temperature control water tank (5); and
a water pump unit (7).

2. The biaxially oriented tubular blown film stretching machine by isostatic pressurized water according to claim 1, wherein the sequential sets of variable speed nip rolls comprising at least 4 sets of nip rolls (1), (2), (3), (4).

3. The biaxially oriented tubular blown film stretching machine by isostatic pressurized water according to claim 1, wherein the first set of nip rolls (1) is installed at the outside of the water tank (5), preferably on the top beside the water tank (5).

4. The biaxially oriented tubular blown film stretching machine by isostatic pressurized water according to claim 1, wherein the second set of nip rolls (2) is installed in the bottom of the water tank (5).

5. The biaxially oriented tubular blown film stretching machine by isostatic pressurized water according to claim 1, wherein the third set of nip rolls (3) is installed on the top of the water tank (5) in the same center alignment with the second set of the below nip rolls (2).

6. The biaxially oriented tubular blown film stretching machine by isostatic pressurized water according to claim 1, wherein the fourth set of nip rolls (4) is installed above of the third set of nip rolls (3), preferably in the same center alignment with the second set of nip rolls (2) and the third set of nip rolls (3).

7. The biaxially oriented tubular blown film stretching machine by isostatic pressurized water according to claim 1, wherein the outside of the temperature control water tank (5) coupling with at least one set of heater bands (6).

8. The biaxially oriented tubular blown film stretching machine by isostatic pressurized water according to claim 1, wherein the temperature control water tank (5) is contained heated water with temperature in the range of 50 to 100 degree Celsius.

9. The biaxially oriented tubular blown film stretching machine by isostatic pressurized water according to claim 1, wherein the hot water temperature at the uppermost level in the temperature control water tank (5) is higher than the water temperature at the lowermost level in the said tank (5) at least 5 degrees Celsius.
